(19) United States
(12) Patent Application Publication
(10) Pub. No.: US 2025/0272068 A1
(43) Pub. Date: Aug. 28, 2025

(54) AUTOMATIC CODE GENERATION FROM INFORMAL SPECIFICATIONS OF TEXT EDITING AND GRAMMAR CORRECTION GUIDELINES

(71) Applicant: Grammarly, Inc., San Francisco, CA (US)

(72) Inventors: Dhruv Kumar, Vancouver (CA); Vipul Raheja, San Francisco, CA (US); Vivek Kulkarni, Mountain View, CA (US); Dimitrios Alikaniotis, New York, NY (US)

(21) Appl. No.: 18/587,303

(22) Filed: Feb. 26, 2024

(51) Int. Cl. G06F 8/35; G06F 40/20

(52) U.S. Cl. CPC G06F 8/35; G06F 40/20

(57) ABSTRACT

The computer-implemented method for processing text data includes receiving text data, receiving a set of descriptions for editing the text data, and generating a set of functions corresponding to the set of descriptions. The process of generating the set of functions for each description in the set of descriptions includes generating a computer code representing a function from the set of functions for processing the text data using a machine learning language model. Further, the method includes applying each one of the set of functions to the text data to generate output text data.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights. ©2023-2024 Grammarly, Inc.

### TECHNICAL FIELD

One technical field is automatic code generation for data processing based on natural language descriptions of data processing rules.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

Rule-based text processing offers versatile techniques for manipulating and analyzing text. Rule-based processing includes word or phrase replacement, text cleaning, text segmentation, pattern matching, pattern extraction, and any other type of processing applicable to text data. The rule-based processing defines specific rules or patterns for identifying and replacing text. Sometimes, these rules or patterns may involve using regular expressions with functions to match specific patterns or words in the text.

In various cases, rule-based processing necessitates the user to define specific rules, which must then be implemented as programming instructions, such as programming scripts, code, or regular expressions. Consequently, rule-based approaches demand that the user be proficient in formulating such instructions and may require a person to be adept in coding.

The present disclosure addresses the challenges associated with users requiring programming instructions for text data processing. The disclosure leverages natural language processing, enabling users to input instructions using natural language and process data accordingly with these instructions.

### SUMMARY

The appended claims may serve as a summary of the invention.

### BRIEF DESCRIPTION OF THE DRAWINGS

In the drawings:

FIG. 1 illustrates a computer system for processing text data in accordance with disclosed embodiments.

FIG. 2 illustrates a method for processing text data in accordance with disclosed embodiments.

FIG. 3 is an interface for processing text data in accordance with disclosed embodiments.

FIG. 4A, FIG. 4B, and FIG. 4C are example diagrams illustrating methods for processing text data in accordance with disclosed embodiments.

FIG. 5A and FIG. 5B are example diagrams illustrating methods for generating programming instructions for processing text data in accordance with disclosed embodiments.

FIG. 6 is an illustrative computer system suitable for implementing the methods described herein in accordance with the disclosed embodiments.

### DETAILED DESCRIPTION

### 1. Overview

The embodiments disclosed herein are only examples, and the scope of this disclosure is not limited to them. Some embodiments may include all, some, or none of the components, elements, features, functions, operations, or steps of the embodiments disclosed herein. Embodiments according to the invention are, in particular, disclosed in the attached claims directed to a method, a storage medium, and a system, wherein any feature mentioned in one claim category, e.g., method, can be claimed in another claim category, e.g., system, as well. The dependencies or references in the attached claims are chosen only for formal reasons. However, any subject matter resulting from a deliberate reference to any previous claims (in particular multiple dependencies) can be claimed so that any combination of claims and the features thereof are disclosed and can be claimed regardless of the dependencies chosen in the attached claims. The subject matter that can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

In the following description, numerous specific details are set forth to provide a thorough understanding of the present disclosure. It will be apparent, however, that embodiments of the present disclosure may be practiced without these specific details. In other instances, well-known structures and devices are shown in block diagram form to avoid unnecessarily obscuring the description of the present disclosure.

The text of this disclosure, in combination with the drawing figures, is intended to state in prose the algorithms that are necessary to program the computer to implement various embodiments at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement embodiments of the present disclosure.

Various embodiments may be described in this disclosure to illustrate various aspects. Other embodiments may be utilized, and structural, logical, software, electrical, and other changes may be made without departing from the scope of the embodiments that are specifically described. Various modifications and alterations are possible and expected. Some features may be described with reference to one or more embodiments or drawing figures, but such features are not limited to usage in the one or more embodiments or figures with reference to which they are described. Thus, the present disclosure is neither a literal description of all embodiments nor a listing of features that must be present in all embodiments.

Headings of sections and the title are provided for convenience but are not intended to limit the disclosure in any way or as a basis for interpreting the claims. Devices that are described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to illustrate one or more aspects of the present disclosure more fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary, and does not imply that the illustrated process is preferred. The steps may be described once per embodiment but need not occur only once. Some steps may be omitted in some embodiments or some occurrences, or some steps may be executed more than once in each embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments need not include the device itself. Techniques and mechanisms described or referenced herein will sometimes be described in singular form for clarity. However, it should be noted that embodiments include multiple iterations of a technique or multiple manifestations of a mechanism unless noted otherwise. Process descriptions or blocks in figures should be understood as representing modules, segments, or portions of code that include one or more executable instructions for implementing specific logical functions or steps in the process. Alternate implementations are included within the scope of embodiments of the present disclosure in which, for example, functions may be executed out of order from that shown or discussed, including substantially concurrently or in reverse order, depending on the functionality involved.

The disclosed methods offer practical applications and technical advantages. The methods leverage one or more machine-learning language models to generate functions based on user-provided descriptions and utilize these functions for text data processing. The functions are created by generating and applying code to process text data. This approach significantly enhances the efficiency of computing resources.

For instance, in an alternative process where a machine learning language model is given a set of natural language rules to apply to text data, it may follow them. However, when the list of rules becomes extensive, the machine-learning language model may exhibit inconsistency in their application. This inconsistency can be influenced by several main factors: (1) a tendency to unevenly focus on the contents at the prompt's start and end, neglecting the middle content; (2) an excessive “cognitive load” on the machine learning model, causing challenges when tasked with multiple simultaneous operations; and a bias towards the training data, causing the ML model to ignore rules that go against what it has been trained on.

The provided method and system address these issues by employing the machine learning language model to generate scripts or code, such as Python code describing the functions. These scripts apply various processing rules to text data, translating natural language rules into executable code. This code can be applied in any suitable order, providing a more reliable and resource-efficient approach to text data processing.

The disclosure also introduces an approach that streamlines the interaction between users and the system by enabling natural language input for function generation. This user-friendly interface enhances accessibility for individuals without extensive programming expertise.

Further, by transforming natural language descriptions into executable code, the method ensures the efficient utilization of computing resources, which is particularly beneficial for tasks involving large datasets or intricate processing requirements. The method is scalable and capable of handling varying degrees of complexity in text-processing tasks. As users articulate their requirements in natural language, it accommodates both straightforward and complex processing scenarios.

Moreover, the generated functions, rooted in natural language descriptions, offer a level of interpretability. Users can comprehend the logic and intent behind the generated code. Additionally, the generated functions for processing text data may integrate with existing text-processing workflows. Users can incorporate these functions into their current systems, enhancing overall efficiency without necessitating a complete overhaul.

Furthermore, using the methods described herein, users can dynamically adjust and modify processing rules by updating the natural language descriptions. This dynamic flexibility enables quick adaptation to changing requirements or evolving patterns in the text data. Additionally, the generated functions can be stored in a database, allowing for reuse in different data processing tasks and facilitating collaboration between technical and non-technical users.

In an embodiment, the approach aligns with practical needs by combining the capabilities of machine-learning language models with user-friendly, adaptable, and resource-efficient solutions for text processing.

Aspects of the disclosed technology include computer-implemented methods for processing text data, which involves receiving text data and a set of descriptions for editing the text data. The method can also include generating a set of functions corresponding to the set of descriptions, by using a machine learning language model to generate a computer code for each description that represents a function for processing the text data. The method can further include applying each function to the text data to generate output text data.

In some embodiments, the set of descriptions is ordered, and the method applies each function in the same order as the set of descriptions. Alternatively, the method can receive ordering instructions for applying the functions, and apply the functions in the order specified by the ordering instructions. The ordering instructions can be an ordered list of function names, where each function has a name associated with its description.

In some embodiments, the method serializes each function by isolating its code, combining it with a wrapper code, and storing the resulting combined code and the function name in a persistent memory. This can facilitate the reuse or sharing of the functions.

In some embodiments, a function can have input parameters, and the method can apply the function by determining the values of the input parameters and providing them to the function when processing the text data. The values of the input parameters can depend on the context of the text data or other factors.

In some embodiments, the set of functions can include at least a first function and a second function, where the first function has output parameters and the second function has input parameters. The method can apply the first function by executing it on the text data and obtaining the output parameters, and use one or more of the output parameters as input parameters for the second function. The method can or can not apply the second function based on the value of the output parameters from the first function.

In some embodiments, the method can receive programming instructions that describe a process of applying the set of functions, and execute the programming instructions to apply the functions. The programming instructions can be written in any suitable programming language, such as Python, Ruby, Perl, JavaScript, Java, PHP, C, or C++.

In some embodiments, the method can apply a function by using the machine learning language model to obtain one or more inputs for the function based on the context of the text data, and provide the inputs to the function when processing the text data. This can allow the function to adapt to the text data and perform more complex or customized operations.

In some embodiments, the method can provide a set of natural language instructions for the machine learning language model on how to execute the set of functions, where the natural language instructions include the names of the functions associated with the descriptions. The method can then generate programming instructions based on the natural language instructions and the function names, and execute the programming instructions to apply the functions. The method can generate the programming instructions by determining, based on the context of the text data, whether a function should be applied to the text data, and by determining the values of the input parameters for a function. The programming instructions can specify applying at least a first function and conditionally applying a second function to the text data, where the first and second functions are from the set of functions. The method can conditionally apply the second function to the output text data from the first function, and determine whether to apply the second function based on some output parameters from the first function.

The disclosure also relates to a computer system that includes one or more processors and one or more non-transitory computer-readable storage media coupled to the processors. The storage media store one or more sequences of instructions that, when executed by the processors, cause the processors to execute the computer-implemented method for processing text data as described above.

The disclosure further relates to one or more non-transitory computer-readable storage media that store one or more sequences of instructions that, when executed by one or more processors, cause the processors to execute the computer-implemented method for processing text data as described above.

### 2. Method and System Description

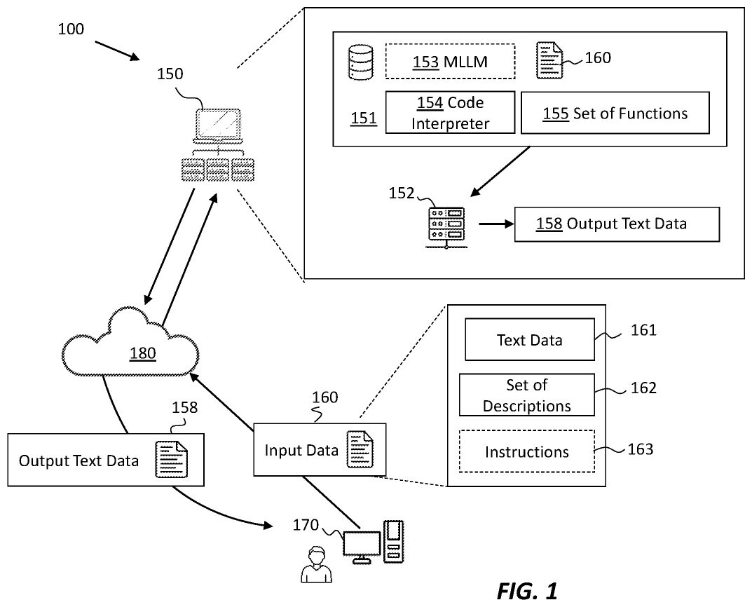

The various methods discussed herein can be performed by system 100, shown in FIG. 1. System 100 includes a client device 170, a server 150, and a network 180 configured such that client device 170 and server 150 can exchange various data. Client device 170 can be any suitable computing device that is capable of connecting to server 150 via network 180. For example, client device 170 may be a laptop, a desktop, a smartphone, a tablet, a workstation, or any other suitable electronic device operated by a user.

Client device 170 can establish communication with server 150 through various means, such as via a dedicated application, an internet browser, or any suitable communication interface that leverages network communication. This interface may support protocols such as the Hypertext Transfer Protocol, WebSockets, TCP/IP, and similar protocols.

Network 180 can include Internet, Intranet, local area network (LAN), wide-area network (WAN), Virtual Private Network (VPN), Wireless Local Area Network (WLAN), campus network, internetwork, or their combinations. Network 180 can facilitate data exchange through various means, such as a LAN card for compatible LANs, a cellular radiotelephone interface for cellular data, or a satellite radio interface for digital data based on satellite wireless networking standards. In all cases, network 180 is configured to transmit and receive digital data streams through electrical, electromagnetic, or optical signals.

Server 150 may include any suitable computing devices, including one or more processors 152 for data processing and one or more memory devices 151 for data storage. In some cases, server 150 may be a distributed computing architecture such as, for example, an edge computing system, a cloud computing system, or, in some cases, a virtual compute instance.

One or more memory devices 151 include one or more non-transitory computer-readable storage media coupled to one or more processors 152. One or more memory devices 151 store one or more sequences of instructions for performing processing of text data using one or more processors 152.

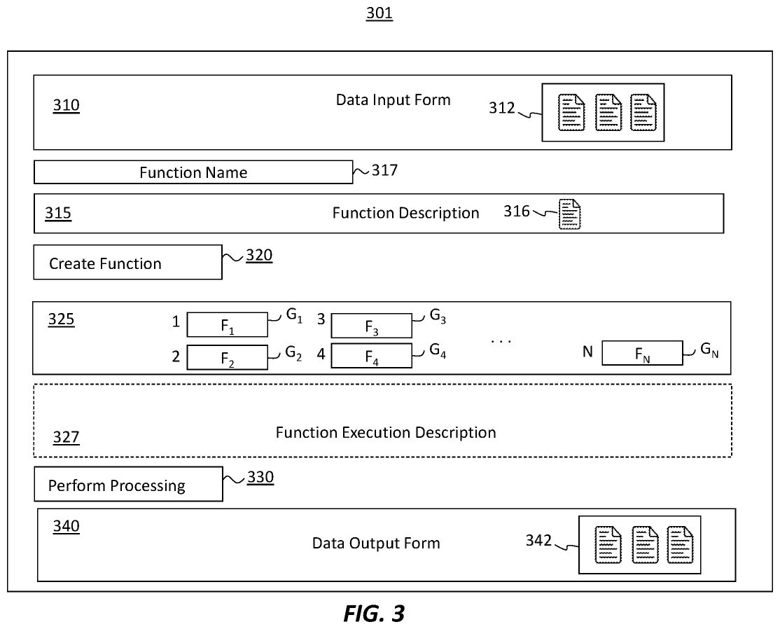

In the illustrated embodiment depicted in FIG. 1, client device 170 is designed to transmit input data 160 to server 150 via network 180. The submission of input data 160 can be facilitated through an interface on client device 170, allowing users to input and review data. An illustrative example of such an interface is further described in FIG. 3 below. It is important to note that the specific design and layout of such an interface may be under the control of server 150. For instance, server 150 can be configured to present users with a webpage featuring form fields for entering input data 160. Additionally, or alternatively, server 150 may be configured to interact with an application operating on client device 170. This interaction may involve updating the interface and exchanging data between client device 170 and server 150.

In various embodiments, input data 160 may include text data 161 that requires to be processed by server 150 and a set of descriptions 162, which outline the specific types of processing required for text data 161. Text data 161 may include text characters from any suitable language and may incorporate special characters, mathematical symbols, icons, bullets, or, in certain instances, emojis or images. Each description from the set of descriptions 162 corresponds to a distinct processing task and has a corresponding name. Further, input data 160 optionally includes instructions 163. Such instructions, when present, describe how to leverage the set of descriptions 162 for processing the text data. In some cases, these instructions specify the sequence in which one or more processors 152 execute the processing tasks associated with each description. Instructions 163 can be formulated in natural language or as scripts, depending on the implementation.

In an illustrative embodiment, a user provides input data 160 via a user interface. This data is subsequently received and stored by server 150 on one or more memory devices 151. As depicted in FIG. 1, these memory devices 151 also contain a machine learning language model (MLLM) 153. MLLM 153 is configured to convert pre-defined descriptions in or among the set of descriptions 162, each corresponding to a distinct processing task, into executable instructions. This conversion process involves translating each description into a corresponding function, represented by one or more programming instructions (e.g., script or code) tailored to perform the designated task. The resulting set of functions 155 is then stored alongside MLLM 153 on the memory devices 151. Additionally, these memory devices may include a code interpreter 154 configured to decipher the code within a set of functions 155, preparing it for execution by one or more processors 152. This enables processors 152 to process text data 161 received within input data 160 by applying the relevant functions from a set of functions 155. Finally, resulting output text data 158 is communicated by one or more processors 152 to the client device 170 via network 180 and displayed on an interface associated with the client device.

In certain embodiments, the functions within a set of functions 155 may be applied to text data 161 in a predetermined sequence for data processing (herein, such data processing is also referred to as functional data processing). Additionally, these functions may accept inputs beyond text data 161, which can subsequently influence the generation of output text data 158. Furthermore, functions within the set may be configured to produce supplementary outputs alongside output text data 158. These additional outputs may comprise variables, parameters, or descriptors that can be leveraged by other functions during subsequent text data processing steps. Output text data 158 includes the processed text data generated by one or more processors 152. It may also incorporate, in some embodiments, formatting information such as font size, font color, text arrangement (e.g., bullet lists), symbols, icons, emojis, or other elements or information related to the presentation of the processed text data to the user of client device 170.

In case when text data 161 includes specialized visual elements, such as emojis or other special characters formed using standardized Unicode characters from the extended Unicode plane, the data processing by one or more processors 152 may not only process text characters but may also be configured to handle image data, enabling tasks such as information extraction from the data or the replacement of image data (or patterns associated with) with alternative images or text data. For instance, when analyzing text data containing emojis, the functional data processing may include determining sentiments associated with the emojis and subsequently processing the text data based on the information derived from these determined sentiments.

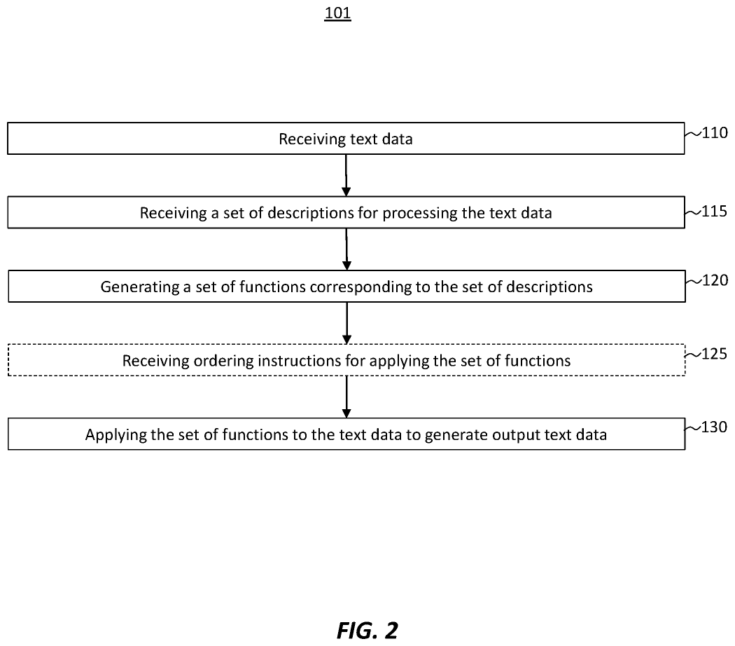

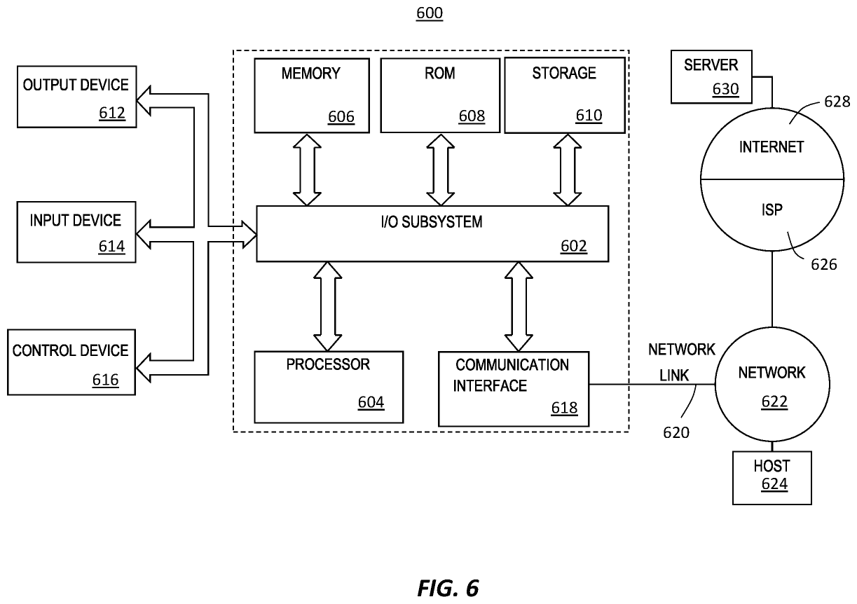

This disclosure, in its various embodiments, describes methods for functional data processing of text data. An example embodiment of method 101 is shown in FIG. 2. Method 101 may be performed by any suitable computing device or a computing system as further described below in relation to FIG. 6. At step 110, method 101 comprises receiving text data for processing. The text data may be submitted to the computing system implementing method 101 via any suitable interface. For instance, the text may be received via an email system, via an application configured to perform functional data processing, or submitted to a server for functional data processing via a dedicated web form.

At step 115, method 101 includes receiving a set of descriptions for editing the text data. In various implementations, each description may be mapped to a function for functional data processing. In the embodiment of method 101, each description in the set of descriptions may be described using natural language. Examples of possible descriptions may include statements such as “Replace the word ‘expert’ with the word teacher if the word ‘expert’ contextually means teacher in the provided text,” “Find all the words in the text that are longer than 12 characters long and replace them with shorter synonyms if such synonyms are available,” “Substitute the numerical values in the text with their corresponding word representations,” “Replace words with rhyming alternatives to add a poetic touch. For example, turn ‘happy’ into ‘snappy’ or a ‘cat’ into a ‘bat,’” “Substitute words with lively synonyms to inject variety and flair. For instance, replace ‘big’ with ‘grand’ or ‘small’ with ‘tiny,’” “Change verb tenses by turning present tense verbs into past,” “adjust the mood of the text by replacing adjectives with more vivid synonyms,” “Infuse tech lingo by replacing everyday terms with technology-related alternatives. For example, turn ‘door’ into ‘portal’ or ‘key’ into ‘code,’” “Turn statements into questions or vice versa for an interactive and engaging effect,” “Introduce industry-specific jargon related to a computer science or terminology for a specialized or professional tone,” or any other suitable examples. In some cases, a description may be relatively simple and may include “Replace word ‘tall’ with word ‘long,’” In some instances, the description is articulated in natural language, comprehensible to a human capable of executing the request specified in the description.

In various embodiments, each description may be entered and submitted to a computing system for functional data processing. The computing system may be configured to interact with a user using any suitable approach. For example, the computing system may provide a suitable interface for the user to enter and submit the description (e.g., via a web form, via email, via an application programming interface (API), or any other suitable interface).

Method 101, at step 120, includes generating a set of functions corresponding to the set of descriptions. In various embodiments, a machine learning language model may be used to analyze descriptions provided by a user and, based on the analysis, generate a function that can be executed to perform a requested functional data processing. In some cases, the generated function for a description may include one or more regular expressions. For instance, a function may include regular expressions such as “\b[A-Za-z0-9._%+-]+@[A-Za-z0-9.-]+\.[A-Z|a-z]{2,}\b” for matching an email address, “\b(0[1-9]|1[0-2])/(0[1-9]|[12][0-9]|3[01])/\d{4}\b” for matching date in a MM/DD/YYYY format, “\b\d{3}[-.\s]?\d{3}[-.\s]?\d{4}\b,” for matching a phone number in various formats, “https?://\S+” for matching a Hypertext Transfer Protocol (HTTP) or Hypertext Transfer Protocol Secure (HTTPS) address, “\b\d+\b” for matching standalone numerical values, “[.,;:!?]” for matching punctuation marks, and the like. In some cases, a function may be a programming script for replacing words. As an example, in step 120, the machine learning language model is configured to generate a function “replace_expert_with_teacher” written as a Python programming script that may be used for replacing a word expert with a word teacher, as shown in TABLE 1.

### Table 1—Example Script for Replacing a Word

import re
def replace_expert_with_teacher(text):
   #Define a regular expression pattern to identify the word “expert”
   expert_pattern=r'\bexpert\b'
   #replace-“expert” with teacher
   if “teacher” in text:
      #Replace “expert” with “teacher”
      modified_text=re.sub(expert_pattern, ‘teacher’, text, flags=re.IGNORECASE)
      return modified_text
   else:
      return text
#Example usage:
original_text=“The expert provided valuable insights.”
modified_text=replace_expert_with_teacher(original_text)
print(modified_text)

In some embodiments, the conditional “if” expression can be omitted to simplify the logic. The machine learning language model is configured to generate various statements of the function “replace_expert_with_teacher” such as expert_pattern being “r'\bexpert\b'” and an “if” statement containing a substitution function “re.sub,” as shown in TABLE 1.

In some cases, when the content of the text data is important for performing functional data processing, a call to an API of a machine-learning language model may be used. For example, TABLE 2 shows an example of Python code using API for interacting with a large language model (LLM).

### Table 2—Example Code Using Api

import llm
#Set your API key
llm.api_key=‘YOUR_API_KEY’
#Define a conversation with a system message and a user message
conversation=[
   {‘role’: ‘system’, ‘content’: ‘You are a language model assistant.’},
   {‘role’: ‘user’, ‘content’: ‘In this context, does “expert” mean “teacher” or something else?
Just say 1 if “yes” and 0 if “no”’}
]
#Generate a response using the LLM Api
response=llm.ChatModel.run(messages=conversation)
#Extract the assistant's reply from the API response
reply=response[‘message’] [‘content’]
#Print the assistant's reply
print (reply)

The Python code imports LLM API generates an inquiry checking if the text data uses the term “expert” to mean a “teacher,” and requests a response to be generated by a gpt-3.5-turbo machine learning language model. Specifically, the Python code is configured to output “1” when the term “expert” within the text data is configured to mean “teacher” and output “0” otherwise.

It should be noted that the machine learning language model can be configured to generate any suitable code for a function that is configured to process text data based on the description provided by a user, and examples shown in TABLE 1 and TABLE 2 are only illustrative. The set of descriptions provided at step 115 of method 101 may include multiple descriptions, and for each description, a corresponding function is generated by the machine learning language model at step 120, as shown in FIG. 2. Once a set of functions is generated corresponding to the set of descriptions, at step 130, the set of functions can be applied to the text data to generate output text data.

Method 101 may further include an optional step 125 of receiving ordering instructions for applying the set of functions. The ordering instructions are configured to specify the order in which generated functions are applied to the text data when processing the text data.

FIG. 3 shows an example interface 301 for interacting with a computer system configured to implement method 101, as shown in FIG. 2. The interface 301 can be used in a variety of ways. It can be, for example, a part of a web-based application, a standalone application, or even a plugin adaptable to various existing applications. These applications can include text-based platforms like word processing, email correspondence, spreadsheet management, chat platforms, and any other software utilizing text data. Within interface 301, users can input text data 312 for processing through a user-friendly data input form 310. The data input form 310 allows users to either type or paste text data 312, offering a flexible approach to data entry.

It should be noted that data input form 310 represents just one possible example, and in certain implementations, text data 312 can be identified or selected without explicit entry into data input form 310. For instance, if the interface 301 functions as a plugin for an existing application, users may highlight text data 312 within that application. The highlighted text can then be selected for processing (e.g., via a suitable mouse input, keyboard input, user gesture, and the like). Additionally, text data 312 might be sourced from a file, and users can input that file into interface 301 by various means, such as attaching, dragging, providing the file name, or utilizing the interface 301 menu to open the file.

As shown in FIG. 3, interface 301 also includes a description input field 315. Description input field 315 is used for entering description 316 of a function for processing the text data that requires editing. In an example implementation, a user may input description 316 using natural language into the description input field 315.

Further, interface 301 includes a function name field 317 for entering a function name that matches description 316 of the function and a create function element 320 for generating the function based on description 316 entered in the description input field 315 and function name field 317. Create function element 320 may be any suitable graphical user interface, such as a push button, icon button, or any other interface tailored to affirm the creation of a function.

Following user interaction with create function element 320, such as pressing a corresponding button, description 316 can be stored in memory, and a corresponding function code is generated. In various embodiments, when the function is created, a corresponding code is automatically generated for that function. The function is then serialized by isolating the code of the function and combining the code with a wrapper code. The outcome is a combined code, which is then stored in a suitable persistent memory. The combined code can be structured to share the identical name as the name of the associated function or be stored in conjunction with the name of the associated function.

In certain implementations, descriptions, such as description 316, can be stored in an ordered manner, reflecting the sequence of function creation. This order can serve as a basis for applying the set of functions to text data 312, corresponding with the sequential arrangement of descriptions. Thus, for a set of ordered descriptions and a corresponding generated set of functions, applying each one of the set of functions to text data 312 is performed in an order of the ordered set of descriptions.

Additionally, interface 301 includes a function listing panel 325 for listing various functions generated for processing the text data. For example, as shown in FIG. 3, function listing panel 325 lists graphical user elements G₁-G_{N} corresponding to functions F₁-F_{N}. Function listing panel 325 can be configured to display an ordered list of graphical user elements G₁-G_{N} indicating the order in which functions F₁-F_{N} are being used for processing text data. For instance, in FIG. 3, function listing panel 325 indicates based on the listing of G₁-G_{N}, that F₁ is performed first, F₂ is performed second, F₃ is performed third, F₄ is performed fourth and F_{N} is performed last. In some implementations, a user may reorder the graphical user elements G₁-G_{N} in any suitable way. The reordering may include moving graphical user elements G₁-G_{N} within function listing panel 325. For example, the user may switch the position of a graphical user element G₄ and G₁ indicating that function F₄ is performed first and function F₁ is performed fourth. It should be appreciated that any other suitable approach besides moving graphical user elements G₁-G_{N} may be used for ordering functions F₁-F_{N}. For example, any suitable ordering instructions may be provided indicating the ordering for applying functions F₁-F_{N} to process text data 312. In some cases, the ordering instructions may include an ordered list of function names.

In various embodiments, when create function element 320 is interacted with by a user, a function is created, and a corresponding graphical user element may be configured to be displayed on the function listing panel 325. In an example implementation, the corresponding graphical user element includes a function name and may be, by default, the last graphical user elements that is listed on function listing panel 325. In some cases, by default, the newly created graphical user element corresponding to the newly created function may be listed as the first graphical user element on function listing panel 325.

Interface 301 further includes a perform processing element 330 for confirming the processing of text data 312 based on the ordered generated functions F₁-F_{N}. Perform processing element 330 may be any suitable graphical user interface such as a push button, icon button, or any other interface tailored to affirm the processing of text data 312.

After processing text data 312, output text data 342 is configured to be displayed in data output form 340. In some implementations, instead of displaying output text data 342, output text data 342 may be stored in suitable memory storage as a file, sent as an email, or communicated via any suitable connection to a computing device in communication with the computing system rendering interface 301.

Optionally, interface 301 includes a function execution description form field 327. This form field serves the purpose of enabling users to input instructions describing how functions, such as the generated functions F₁-F_{N}, should be executed to process text data 312. While execution descriptions entered in the function execution description form field 327 could involve straightforward ordering instructions for the execution of functions F₁-F_{N}, they also may allow for a more nuanced approach. Specifically, an execution description may take a form of a natural language description explaining how to execute the generated functions F₁-F_{N}. For instance, this execution description could include conditional statements dictating the execution of certain functions F₁-F_{N} based on specific conditions arising during the processing of text data 312. To illustrate, conditions may be set such that function F₂ is not executed unless function F₁ has identified a particular pattern within the text data 312. Alternatively, the execution description may include a requirement to ascertain whether function F₃ identifies a specified pattern within text data 312. If such a pattern is identified, the description may further instruct to execute functions F₄ and F₅ multiple times for the processing of text data 312.

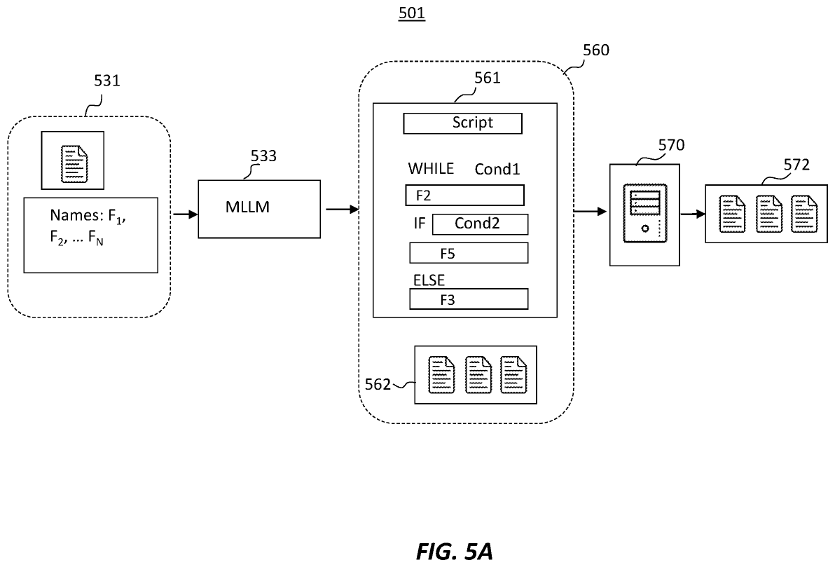

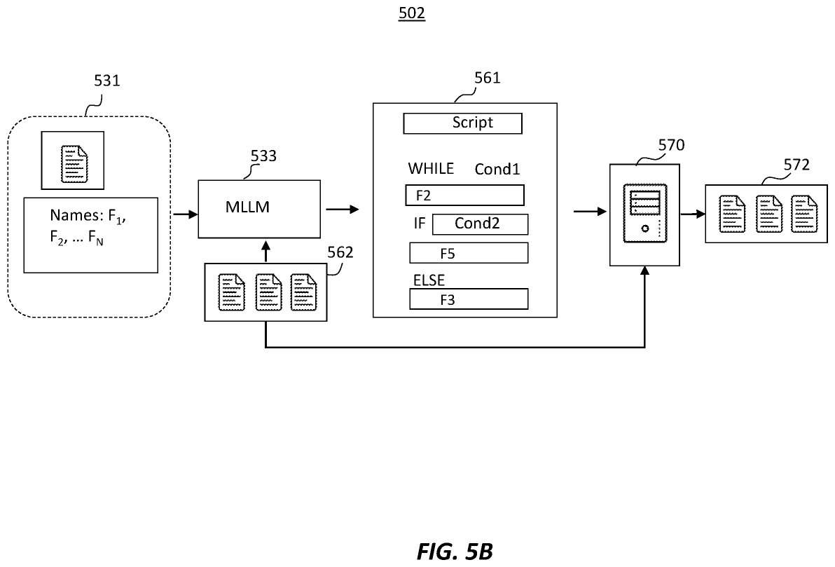

In various cases, the natural language description explaining how to execute the generated set of functions F₁-F_{N} is configured to be processed by a machine learning language model to generate programming instructions describing a process of applying these functions. Such an approach is further described below in relation to FIGS. 5A and 5B. Alternatively, in some implementations, a user may input the programming instructions into a function execution description form field 327, thereby not requiring the generation of the programming instructions by a machine learning language model. It should be appreciated that programming instructions can be input into interface 301 via any suitable approach (e.g., by providing a file name of the file containing such programming instructions).

Consequently, when the programming instructions are available for executing the set of functions F₁-F_{N} for processing text data, a method for processing text data may include receiving such programming instructions describing a process of applying the set of functions, and executing the programming instructions, thereby applying the set of functions F₁-F_{N} for processing text data.

The programming instructions may be implemented in any suitable way and may include a Python code, a Ruby code, a Perl Script, a JavaScript code, a Java code, a PHP code, a C code, a C++ code, or any other suitable code written in any suitable computer language.

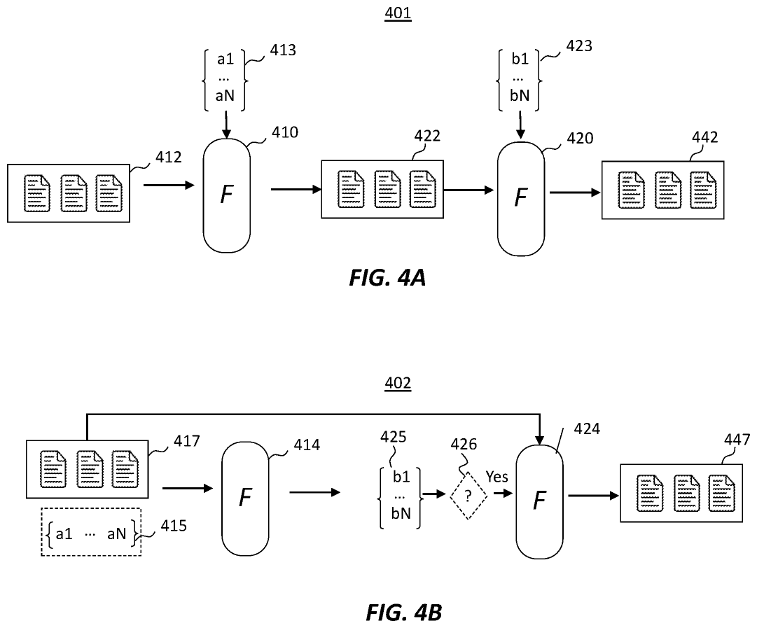

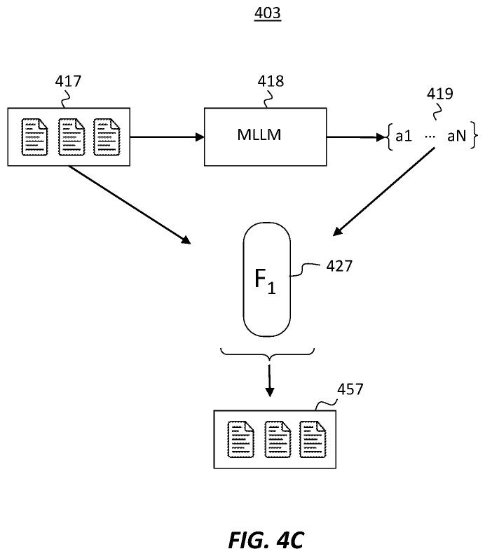

In some embodiments, a function in a set of functions corresponding to a set of descriptions includes input parameters determining specific ways the function is applied to text data, such as text data 312. Applying such a function to the text data includes determining input parameter values corresponding to the input parameters, and executing the function on the text data, having the input parameter values as the input parameters. Such a process is illustrated in a diagram 401 shown in FIG. 4A. Diagram 401 shows both input parameter values 413 denoted by {a1 . . . aN} as well as text data 412 serving as inputs for function 410. Function 410 is configured to output text data 422, which along with input parameter values 423 denoted by {b1 . . . bN} is further input into function 420, configured to output text data 442.

Example input parameters for functions may include parameters indicating a language for text data, contextual information that can be obtained by processing the text data using other functions that can, for example, utilize machine learning language models, a type of text (e.g., legal, medical, technical) associated with the text data, specifying whether or not the function should be case sensitive or any other suitable parameters that can affect how the function may perform text data processing.

FIG. 4B shows another diagram 402 for processing text data using a first function 414 and a second function 424, which may be particular functions among a set of functions for processing the text data 417. Diagram 402 shows that first function 414 is configured to receive text data 417 and optionally input parameters 415 denoted by {a1 . . . aN} and output a set of output parameters 425 denoted by {b1 . . . bN}. Further second function 424 is configured to receive at least one of the set of output parameters 425 as input parameters as well as text data 417 as indicated by corresponding arrows in FIG. 4B. Subsequently, the second function 424 is configured to process text data 417 subject to at least one of the set of output parameters 425 to output text data 447.

To further illustrate the use of a process shown in diagram 402, first function 414 may be configured to extract contextual information from text data 417. For instance, first function 414 may be configured to determine if the term “expert” within text data 417 signifies a “teacher.” First function 414 may output “1” for “yes” and “0” for “no.” Consequently, second function 424 is configured to replace the term “expert” with the word “teacher” within text data 417 if such a term is used to denote the “teacher.” Therefore, when the one of the set of output parameters 425 from the first function 414 confirms a value of “1” (indicating that the term “expert” corresponds to “teacher”), and this value is employed as one of the output parameters 425 for input into the second function 424, the second function 424 proceeds to process text data 417 by replacing the occurrence of the word “expert” with the word “teacher.”

In some cases, as optionally indicated by condition 426 in FIG. 4B, second function 424 may not be applied based on values of one or more of the set of output parameters 425 produced by first function 414. For example, if the first function 414 returns an indication that the word “expert” is not found in text data 417, the second function 424 may not be applied.

FIG. 4C shows diagram 403, which illustrates an embodiment of a process that can be a variation of a process shown in diagram 402 of FIG. 4B. As shown in FIG. 4C, applying one or more functions 427 (e.g., function F₁, as shown in FIG. 4C) from the set of functions for processing text data 417 includes using a machine learning language model 418 to obtain one or more inputs 419 denoted by {a1 . . . aN} for function F₁ based on context data of text data 417, and providing the one or more inputs 419 for function F₁ to process text data 417 to obtain output text data 457. It should be noted that while one function, F₁, is shown in FIG. 4C, multiple functions 427 may be used for obtaining output text data 457 based on one or more inputs 419.

FIG. 5A shows a diagram 501 illustrating a method of applying a set of functions to text data. Applying the functions includes first generating programming instructions describing a process of applying the set of functions using a suitable machine-learning language model. As shown in FIG. 5A, natural language instructions 531 are provided for a machine learning language model 533. Natural language instructions 531 use function names for a set of functions to formulate instructions that can be used by machine learning language model 533 to generate programming instructions 561. Programming instructions 561 may include various logical statements (e.g., conditional IF statements, WHILE, and the like) to determine the logical sequence of execution of various functions for text processing. As an illustration, in FIG. 5A, programming instructions 561 show functions F₂, F₅, and F₃, among functions from a set of functions F₁-F_{N} that can be executed by programming instructions 561. In various cases, programming instructions 561, together with text data 562, can be used as an input 560 for a computing system 570, which is configured to execute programming instructions 561 to process text data 562 and output text data 572.

FIG. 5B shows a diagram 502 which can be a variation of diagram 501. Diagram 502 shows that, in some cases, text data 562 can be used as an input to machine learning language model 533 to provide context information that can be used for generating programming instructions 561. In one implementation, the context information can be used to determine, based on the natural language instructions 531, whether a function from the set of functions F₁-F_{N} should be applied to process text data 562.

In certain scenarios, programming instructions can be iteratively applied to output text data derived from the processing of input text data until a specific condition is fulfilled. As an illustration, the programming instructions may initially target the input text data, aiming to identify and replace specific patterns within it. Subsequently, the process extends to the output text data, where additional steps, such as determining a sentiment value (e.g., categorizing the output as happy, sad, angry, etc.), are executed. If a predetermined condition remains unmet (e.g., the message is not classified as happy), the iterative processing of the output text data continues until the condition is satisfied (e.g., until the output text data is recognized as representing a happy message).

In certain instances, the generation of programming instructions, such as programming instructions 561, involves the determination of input parameters for one or more functions within the set of functions utilized by the programming instructions. As described earlier, these input parameters may play a role in influencing the execution of the function to which they are supplied. For instance, these parameters may guide a function in determining whether it should be invoked for the processing of text data.

Furthermore, the programming instructions can utilize output data from one or more functions to determine how various functions invoked by the programming instructions should execute. For example, the choice of applying particular functions to the text data may depend on the values of parameters in the output data. In an example implementation, the programming instructions may describe applying at least a first function and conditionally applying a second function to the text data, the first and the second functions being functions from the set of functions. In various cases, the second function is conditionally applied to output text data that is being output by the first function after processing the text data. The application of the second function may be based on at least some output parameters of the first function. For example, if the output parameters indicate that a particular pattern is not present within the text data, the second function may not be applied.

### 3. Implementation Example—Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

FIG. 6 is a block diagram that illustrates an example computer system with which an embodiment may be implemented. In the example of FIG. 6, a computer system 600 and instructions for implementing the disclosed technologies in hardware, software, or a combination of hardware and software, are represented schematically, for example, as boxes and circles, at the same level of detail that is commonly used by persons of ordinary skill in the art to which this disclosure pertains for communicating about computer architecture and computer systems implementations.

Computer system 600 includes an input/output (I/O) subsystem 602 which may include a bus and/or other communication mechanism(s) for communicating information and/or instructions between the components of the computer system 600 over electronic signal paths. I/O subsystem 602 may include an I/O controller, a memory controller and at least one I/O port. The electronic signal paths are represented schematically in the drawings, for example as lines, unidirectional arrows, or bidirectional arrows.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system, a graphics processing unit (GPU), or a digital signal processor or ARM processor. Processor 604 may comprise an integrated arithmetic logic unit (ALU) or may be coupled to a separate ALU.

Computer system 600 includes one or more units of memory 606, such as a main memory, which is coupled to I/O subsystem 602 for electronically digitally storing data and instructions to be executed by processor 604. Memory 606 may include volatile memory such as various forms of random-access memory (RAM) or other dynamic storage device. Memory 606 may also be used for storing temporary variables or other intermediate information during the execution of instructions to be executed by processor 604. Such instructions, when stored in non-transitory computer-readable storage media accessible to processor 604, can render computer system 600 into a special-purpose machine that is customized to perform the operations specified in the instructions.

Computer system 600 further includes non-volatile memory such as read-only memory (ROM) 608 or another static storage device coupled to I/O subsystem 602 for storing information and instructions for processor 604. ROM 608 may include various forms of programmable ROM (PROM), such as erasable PROM (EPROM) or electrically erasable PROM (EEPROM). A unit of persistent storage 610 may include various forms of non-volatile RAM (NVRAM), such as FLASH memory, solid-state storage, magnetic disk, or optical disk such as CD-ROM or DVD-ROM and may be coupled to I/O subsystem 602 for storing information and instructions. Storage 610 is an example of a non-transitory computer-readable medium that may be used to store instructions and data, which, when executed by the processor 604, cause performing computer-implemented methods to execute the techniques herein.

The instructions in memory 606, ROM 608, or storage 610 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation layer, application layer, and data storage layer, such as a relational database system using structured query language (SQL) or no SQL, an object store, a graph database, a flat file system, or other data storage.

Computer system 600 may be coupled via I/O subsystem 602 to at least one output device 612. In one embodiment, output device 612 is a digital computer display. Examples of a display that may be used in various embodiments include a touchscreen display, a light-emitting diode (LED) display, a liquid crystal display (LCD), or an e-paper display. Computer system 600 may include other type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators, or servos.

At least one input device, 614, is coupled to I/O subsystem 602 for communicating signals, data, command selections, or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. The control device 616 may be a touchpad, a mouse, a trackball, or cursor direction keys for communicating direction information and command selections to processor 604 and for controlling cursor movement on the output device 612. Control device 616 may have at least two degrees of freedom in two axes, a first axis (e.g., x) and a second axis (e.g., y), that allows the device to specify positions in a plane. Another type of input device may be a wired, wireless, or optical control device such as a joystick, wand, console, steering wheel, pedal, gearshift mechanism or other type of control device. Input device 614 may include a combination of multiple different input devices, such as a video camera and a depth sensor.

In another embodiment, computer system 600 may comprise an internet of things (IoT) device in which one or more of the output device 612, input device 614, and control device 616 are omitted. Or, in such an embodiment, the input device 614 may comprise one or more cameras, motion detectors, thermometers, microphones, seismic detectors, other sensors or detectors, measurement devices or encoders, and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware, and interfaces for generating position reporting packets, notifications, pulse or heartbeat signals, or other recurring data transmissions that specify a position of the computer system 600, alone or in combination with other application-specific data, directed toward host 624 or server 630.

Computer system 600 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 600 in response to processor 604 executing at least one sequence of at least one instruction contained in main memory 606. Such instructions may be read into main memory 606 from another storage medium, such as storage 610. Execution of the sequences of instructions contained in main memory 606 causes processor 604 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire, and fiber optics, including the wires that comprise a bus of I/O subsystem 602. Transmission media can also take the form of acoustic or light waves, such as those generated during radio-wave and infrared data communications.

Various forms of media may be involved in carrying at least one sequence of at least one instruction to processor 604 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 600 can receive the data on the communication link and convert the data to a format that can be read by computer system 600. For instance, a receiver such as a radio frequency antenna or an infrared detector can receive the data carried in a wireless or optical signal and appropriate circuitry can provide the data to I/O subsystem 602 such as place the data on a bus. I/O subsystem 602 carries the data to memory 606, from which processor 604 retrieves and executes the instructions. The instructions received by memory 606 may optionally be stored on storage 610 either before or after execution by processor 604.

Computer system 600 also includes a communication interface 618 coupled to I/O subsystem 602. Communication interface 618 provides a two-way data communication coupling to network link(s) 620 that are directly or indirectly connected to at least one communication networks, such as a network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 622 broadly represents a local area network (LAN), wide-area network (WAN), campus network, internetwork, or any combination thereof. Communication interface 618 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic, or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may provide a connection through network 622 to host 624.

Furthermore, network link 620 may provide a connection through network 622 or to other computing devices via internetworking devices and/or computers that are operated by an Internet Service Provider (ISP) 626. ISP 626 provides data communication services through a worldwide packet data communication network represented as Internet 628. A server 630 may be coupled to Internet 628. Server 630 broadly represents any computer, data center, virtual machine, or virtual computing instance with or without a hypervisor, or computer executing a containerized program system such as DOCKER or KUBERNETES. Server 630 may represent an electronic digital service that is implemented using more than one computer or instance and that is accessed and used by transmitting web services requests, uniform resource locator (URL) strings with parameters in HTTP payloads, API calls, app services calls, or other service calls. Computer system 600 and server 630 may form elements of a distributed computing system that includes other computers, a processing cluster, server farm or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 630 may comprise a web application server that hosts a presentation layer, application layer and data storage layer such as a relational database system using structured query language (SQL) or no SQL, an object store, a graph database, a flat file system or other data storage.

Computer system 600 can send messages and receive data and instructions, including program code, through the network(s), network link 620 and communication interface 618. In the Internet example, a server 630 might transmit a requested code for an application program through Internet 628, ISP 626, network 622 and communication interface 618. The received code may be executed by processor 604 as it is received, and/or stored in storage 610, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In an embodiment, switches may be performed when tasks perform input/output operations when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the present disclosure have been described with reference to numerous specific details that may vary from implementation to implementation. The specification and drawings are, accordingly, to be regarded in an illustrative rather than a restrictive sense. The sole and exclusive indicator of the scope of the present disclosure, and what is intended by the applicants to be the scope of the present disclosure, is the literal and equivalent scope of the set of claims that issue from this application, in the specific form in which such claims issue, including any subsequent correction.

What is claimed is:

1. A computer-implemented method for processing text data, the computer-implemented method comprising:
receiving text data;
receiving a set of descriptions for editing the text data;
generating a set of functions corresponding to the set of descriptions, wherein the generating comprises, for each description in the set of descriptions generating a computer code representing a function from the set of functions for processing the text data using a machine learning language model;
applying each one of the set of functions to the text data to generate output text data.

2. The computer-implemented method of claim 1:
wherein the set of descriptions is ordered;
further comprising applying each one of the set of functions in an order of the set of descriptions.

3. The computer-implemented method of claim 1 further comprising:
receiving ordering instructions for applying each one of the set of functions;
applying each one of the set of functions in an order described in the ordering instructions.

4. The computer-implemented method of claim 3, wherein each one of the set of functions includes a function name, and wherein the ordering instructions is an ordered list of function names.

5. The computer-implemented method of claim 1, further comprising serializing each function of the set of functions by isolating a code of the function, combining the code with a wrapper code resulting in a combined code, and storing the combined code and a name associated with the function in a persistent memory.

6. The computer-implemented method of claim 1:
wherein a function in the set of functions includes input parameters;
further comprising applying the function by determining input parameter values corresponding to the input parameters and applying the function on the text data, having the input parameter values as the input parameters.

7. The computer-implemented method of claim 1:
wherein the set of functions includes at least a first function and a second function, the first function including at least output parameters, and the second function includes at least input parameters;
further comprising applying the first function at least in part by executing the first function on the text data, thereby obtaining the output parameters, using at least one of the output parameters of the first function as one of the input parameters of the second function.

8. The computer-implemented method of claim 7, wherein the applying of the second function is not performed based on a value of the at least one of the output parameters of the first function.

9. The computer-implemented method of claim 6 further comprising:
receiving programming instructions describing a process of applying the set of functions;
wherein applying the set of functions includes executing the programming instructions.

10. The computer-implemented method of claim 9, wherein the programming instructions have one of a Python code, a Ruby code, a Perl Script, a JavaScript code, a Java code, a PHP code, a C code, or a C++ code.

11. The computer-implemented method of claim 1, further comprising applying a function from the set of functions to the text data at least in part by using the machine learning language model, obtaining one or more inputs for the function based on context data of the text data, and providing the one or more inputs to the function, when using the function to process the text data.

12. The computer-implemented method of claim 1, further comprising applying the set of functions to the text data by:
providing a set of natural language instructions for the machine learning language model on how to execute the set of functions, the set of natural language instructions including a set of function names associated with the set of descriptions;
based on the set of natural language instructions, and the set of function names, generating programming instructions describing a process of applying the set of functions;
executing the programming instructions.

13. The computer-implemented method of claim 12, further comprising generating the programming instructions at least in part by determining based on a context of the text data whether a function from the set of functions should be applied to the text data.

14. The computer-implemented method of claim 12, further comprising generating the programming instructions at least in part by determining values for input parameters for a function from the set of functions.

15. The computer-implemented method of claim 12:
wherein the programming instructions specify applying at least a first function and conditionally applying a second function to the text data, the first function and the second function being from the set of functions;
further comprising conditionally applying the second function to output text data being output by the first function after processing the text data;
determining whether to apply the second function based on at least some output parameters from the first function.

16. A computer system comprising:
one or more processors;
one or more non-transitory computer-readable storage media coupled to the one or more processors and storing one or more sequences of instructions which, when executed using the one or more processors, cause the one or more processors to execute:
receiving text data;
receiving a set of descriptions for editing the text data;
generating a set of functions corresponding to the set of descriptions, wherein the generating comprises, for each description in the set of descriptions generating a computer code representing a function from the set of functions for processing the text data using a machine learning language model;
applying each one of the set of functions to the text data to generate output text data.

17. The computer system of claim 16:
wherein the set of descriptions is ordered;
the one or more non-transitory computer-readable storage media further comprising sequences of instructions which, when executed using the one or more processors, cause the one or more processors to execute applying each one of the set of functions in an order of the set of descriptions.

18. The computer system of claim 16, the one or more non-transitory computer-readable storage media further comprising sequences of instructions which, when executed using the one or more processors, cause the one or more processors to execute:
receiving ordering instructions for applying each one of the set of functions;
applying each one of the set of functions in an order described in the ordering instructions.

19. The computer system of claim 18, wherein each one of the set of functions includes a function name, and wherein the ordering instructions is an ordered list of function names.

20. The computer system of claim 16, the one or more non-transitory computer-readable storage media further comprising sequences of instructions which, when executed using the one or more processors, cause the one or more processors to execute serializing each function of the set of functions by isolating a code of the function, combining the code with a wrapper code resulting in a combined code, and storing the combined code and a name associated with the function in a persistent memory.
